(19) United States
(12) Patent Application Publication
(10) Pub. No.: US 2012/0156368 A1
(43) Pub. Date: Jun. 21, 2012

(54) Corrosion Resistant Gas Cell Formed From Nickel Plated Stainless Steel

(75) Inventor: Gerald Auth, Laguna Beach, CA (US)

(73) Assignee: MIDAC CORPORATION, Costa Mesa, CA (US)

(21) Appl. No.: 12/973,748

(22) Filed: Dec. 20, 2010

(51) Int. Cl. B05D 5/06; B05D 3/12

(52) U.S. Cl. 427/162

(57) ABSTRACT

Method of making a corrosion resistant gas cell including an end cap having integral reflecting mirrors and sealing surfaces, the method involving the steps of: rough shaping a plate of stainless steel to near net dimensions using a standard-precision CNC milling machine and standard cutting bits to form a near net stainless steel core; coating the near net stainless steel core with a layer of nickel that is at least 0.002″ thick by immersing the near net stainless steel core in a bath of nickel sulfamate for at least eight hours; and precision shaping the coating of nickel with a precision milling machine to form the integral reflecting mirrors and sealing surfaces of the gas cell

PRIORITY CLAIM

This patent application claims the benefit of the priority date of U.S. Provisional Patent Application Ser. No. 60/288,100, filed on Dec. 18, 2009, and entitled CORROSION RESISTANT GAS CELL FORMED FROM NICKEL PLATED STAINLESS STEEL pursuant to 35 USC 119. The entire contents of this provisional patent application are hereby expressly incorporated by reference.

### FIELD OF THE INVENTION

The present invention relates generally to a spectrometer accessory known as a long pass gas cell (aka “White Cell”) and, more particularly, to a method of efficiently and cost-effectively manufacturing a corrosion resistant gas cell for use in a corrosive environment.

### BACKGROUND OF THE INVENTION

Online process management is critical in the efficient manufacture of drugs and chemicals. In a typical situation, online process management is accomplished with FTIR spectrometers and suitable probes or cells that receive or are introduced into the liquids and/or gases of the process. The absorption spectra from the FTIR spectrometer shows what molecules are present, and in what absolute and relative amounts, so that the control engineers know when to go to the next step and thereby maximize the quality and efficiency of the process in question.

A long pass gas cell or “White Cell” is a common spectrometer accessory that is used to measure gas concentrations by repeatedly passing an IR beam through a volume of gas. The IR beam bounces back and forth between reflecting mirrors located at each end of the White Cell. An exemplary White Cell is disclosed in U.S. Pat. No. 5,440,143, the entire disclosure of which is incorporated herein by reference.

FIG. 1 illustrates a typical White Cell 10, comprising a cylindrical body 20 and a pair of end caps 32, 32 which carry spherical mirrors (not separately numbered).

As a general observation, aluminum is very desirable material for making White Cells because its material properties make it relatively easy to shape with standard Computer Numerical Control (CNC) milling equipment and conventional tool steel cutting inserts. The White Cell disclosed in the '143 patent, for example, is made of aluminum (col. 3, lines 30-32).

White Cell's are traditionally made by starting with a material such as 6061-T6 aluminum round rod and then using a CNC milling machine to cut a cylindrical pipe shaped body with end flanges and to cut the corresponding end caps that mount to the flanges and internally support the reflecting mirrors that face one another.

Diamond turning machines are similar to a lathe in that both spin a workpiece while a cutting tool cuts the revolving surface, but a diamond turning machine is so precise that it leaves behind a gleaming reflective surface that often requires no further finishing. In essence, a diamond turning machine is a special kind of CNC lathe that is equipped with diamond-tipped cutting elements, but it is a precision machine in that its elements are moved so precisely that the machine is cable of achieving sub-nanometer level surface finishes. The diamond cut surfaces are so smooth that it is possible to create high quality optical surfaces (e.g. surface finishes with a roughness as low as 20 Å RMS). A typical diamond turning machine has precision lays and an air-bearing spindle.

Precision machines like diamond turning machines can only be used with a limited number of raw materials. Some raw materials that are generally compatible with diamond turning include aluminum, copper, gold, silver, platinum, electrolyzed nickel, beryllium, copper, germanium, silicon, plastic, and lithium niobate. Metals that contain carbon are not compatible because of the chemical reaction that occurs between the carbon and the diamond tool due to the high temperatures of machining.

Aluminum is amongst the materials that are amenable to precision shaping on a diamond turning machine, but aluminum is only suitable for creating a White Cell if it is intended for use in a non-corrosive environment.

In particular, aluminum is not practical for making a corrosion resistant White Cell for analyzing certain processes that involve highly corrosive gases (e.g. hydrogen bromide or HBr, hot wet HCl, and HF). In such environments, an aluminum White Cell might be destroyed in a matter of seconds. In such cases, therefore, it is necessary to manufacture the White Cell from a metal other than aluminum, e.g. a nickel alloy or stainless steel. The need to use a material other than aluminum has, to date, meant that diamond turning with a precision machine cannot be used to create a White Cell for use in a corrosive environment.

White Cells intended for a highly corrosive environment are usually made by using standard CNC machines to machine nickel alloy or stainless steel and, because this ordinary, standard precision machining process is not suitable for forming optical surfaces, by separately forming the reflecting mirrors by hand lapping separate blocks of nickel 200 to form the mirrors, plating the mirrors with gold, and then mounting the mirrors to the nickel alloy or stainless steel end caps. Because of this multi-step approach, it can takes hours or even days to painstakingly align the hand lapped reflecting mirrors relative to the end caps so that they correctly bounce the IR beam back and forth within the White Cell.

As such, there remains a need for an improved corrosion resistant gas cell for use in a corrosive environment and a method of manufacturing the same.

### BRIEF SUMMARY OF THE INVENTION

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

The present invention specifically addresses and alleviates the above mentioned deficiencies associated with the prior art. More particularly, the present invention comprises a method for of efficiently and cost-effectively manufacturing a corrosion resistant gas cell for use in a corrosive environment.

In a first aspect, the invention comprises a method of making a corrosion resistant gas cell including an end cap having integral reflecting mirrors and sealing surfaces comprising the steps of: rough shaping a plate of stainless steel to near net dimensions using standard machining techniques to form a near net stainless steel core; coating the near net stainless steel core with a layer of nickel to form a nickel coating; and precision shaping the nickel coating with a precision machine to form the integral reflecting mirrors and sealing surfaces of the gas cell.

In a second aspect, the invention comprises a method of making a corrosion resistant gas cell including an end cap having integral reflecting mirrors and sealing surfaces comprising the steps of: rough shaping a plate of stainless steel to near net dimensions using a standard-precision CNC milling machine and standard cutting bits to form a near net stainless steel core; coating the near net stainless steel core with a layer of nickel that is at least 0.002″ thick by immersing the near net stainless steel core in a bath of nickel sulfamate for at least eight hours; and precision shaping the coating of nickel with a precision milling machine to form the integral reflecting mirrors and sealing surfaces of the gas cell.

In a third aspect, the invention comprises a method of making a corrosion resistant gas cell including an end cap having integral reflecting mirrors and sealing surfaces comprising the steps of: rough shaping a plate of stainless steel to near net dimensions using a standard-precision CNC milling machine and standard cutting bits to form a near net stainless steel core; coating the near net stainless steel core with a layer of nickel that is provided in a pure form having impurities in the 0-5 PPM range; and precision shaping the coating of nickel with a diamond turning machine that provides a surface finish with a roughness of about 20 Å RMS to form the integral reflecting mirrors and sealing surfaces of the gas cell.

These, as well as other advantages of the present invention, will be more apparent from the following description and drawings. It is understood that changes in the specific structures and/or steps that are shown and described may be made within the scope of the claims, without departing from the spirit of the invention.

### BRIEF DESCRIPTION OF THE DRAWINGS

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

FIG. 1 is a cross-sectional view of a typical long pass gas cell 10 formed from a cylindrical body 20 and end caps 31, 32 carrying spherical mirrors;

FIG. 2 is a series of related figures that conceptually illustrate how an end cap 132 (comparable to end cap 32 of FIG. 1, but having integral mirrors 143a and sealing surfaces 143b) may be manufactured according to a preferred embodiment of the invention by starting with a plate 141 of stainless steel, using standard machining techniques to create a near net core 142, plating the near net core with a unusually thick and nearly pure nickel coating 143, and then precision machining the nickel coated core to provide an end cap 132 with integral mirrors 143a and sealing surfaces 143b

FIG. 3 is a flow chart of a method of manufacturing a corrosion resistant gas cell according to a first preferred embodiment of the invention;

FIG. 4 is flow chart of a method of manufacturing a corrosion resistant gas cell according to a second preferred embodiment of the invention; and

FIG. 5 is flow chart of a method of manufacturing a corrosion resistant gas cell according to a third preferred embodiment of the invention.

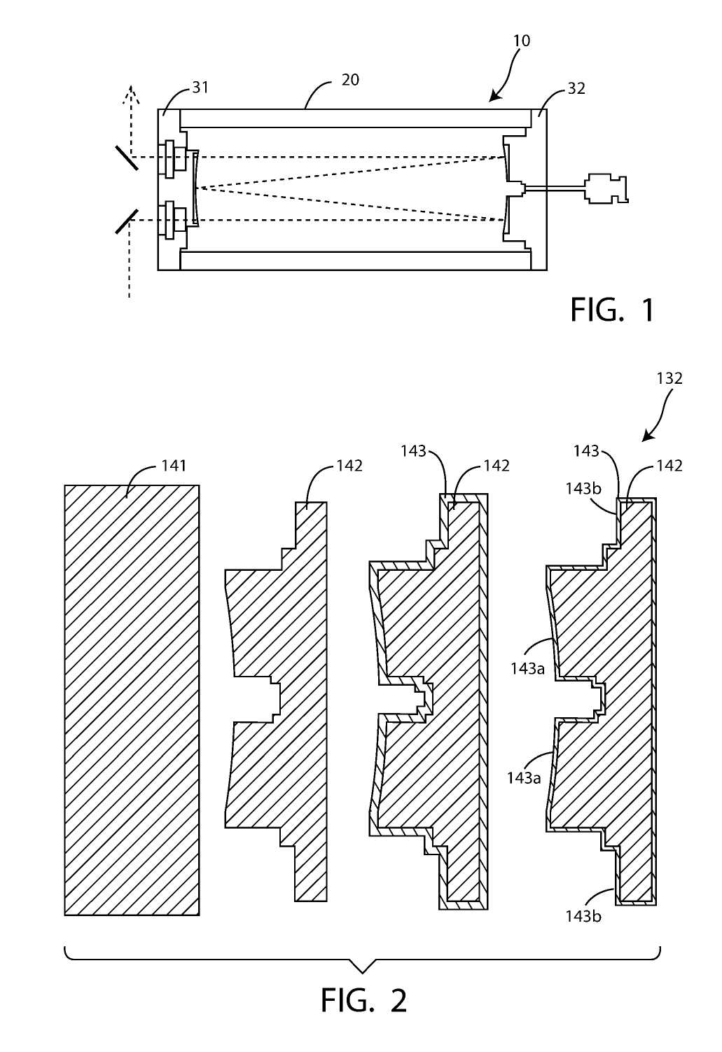

### DETAILED DESCRIPTION OF THE PREFERRED EMBODIMENTS

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions may be accomplished by different embodiments that are also intended to be encompassed within the spirit of the invention.

Applicant has developed a new technology for making improved White Cells with precision machine such as a diamond turning machine. In particular, applicant's improved White Cells are made according to a unique process that involves a special jig used on the diamond turning machine, one that allows the spherical reflecting mirrors and adjacent sealing surfaces to be integrally formed to extremely high precision on the end caps with the diamond turning machine. The advantage of this process is that the spherical mirrors are consistently positioned, aligned, and ready-to-go upon assembly of the end caps to the cylindrical body. In other words, using this technology, it is no longer necessary for somebody to hand lap separate mirrors and then painstakingly align the mirrors for hours on end.

Unfortunately, neither nickel alloys nor stainless can be cut with a diamond turning machine due to rapid tool wear or tool breakage. At first glance, therefore, applicant's improved White Cell formed on a diamond turning machine is only useful with aluminum and thus suitable only for making White Cells to be used in a relatively non-corrosive environment—and not suitable for use in making corrosion resistant White Cells.

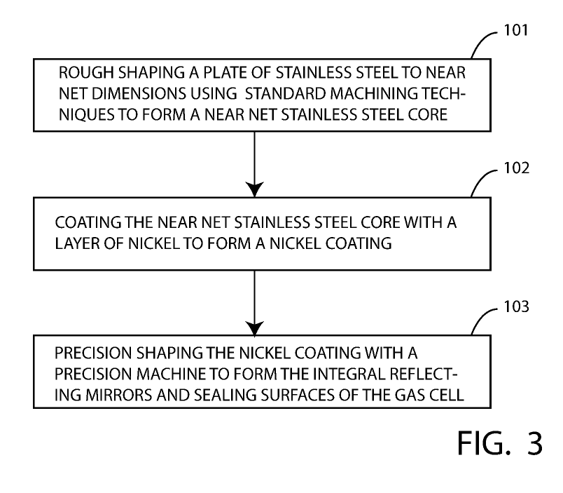

With reference to FIGS. 2 and 3, it recently occurred to applicant, however, that he could make a precision made White Cell that is also resistant to corrosive gases by:

(1) rough shaping a plate 141 of stainless steel that is resistant to corrosion but can reasonably be machined and welded (e.g. type 316 stainless steel) to “near net” dimensions using a standard-precision CNC milling machine and standard cutting bits, thereby providing a near net core 142 (step 101);

(2) coating the “rough” surfaces of the “near net” stainless steel core 142 with an unusually thick layer of nearly pure nickel to form a nickel coating 143 (step 102); and

(3) precision shaping the coating 143 of nearly pure nickel with a precision machine such as a diamond turning machine to form the integral reflecting mirrors 143a and sealing surfaces 143b of the White Cell (step 103).

From applicant's experimentation to date, the preferred approach to coating the near net core 142 of stainless steel with virtually pure nickel (e.g. nickel having impurities like copper or iron in the 0-5 PPM range, preferably 0-2 PPM) involves the creation of a pure nickel coating 143 that is at least 0.002″ thick (more than 20-times thicker than the normal plating thickness of about 0.0001″). Applicant accomplished this by having his plated immerse the near net stainless steel core 142 in a bath of nickel sulfamate for at least eight hours. The only plating process that shows promise so far is the sulfamate process with no brighteners or any other additives, but other plating processes may be possible. In order to achieve a soft nickel coating 143, the nickel must be very pure.

As hoped, applicant was able to use a diamond turning lathe to precision machine the nickel coating 143 of the nickel plated stainless steel 142.

The highly beneficial result of this unique process is a corrosion resistant White Cell that can be manufactured with all of the benefits that flow from using a diamond turning machine that is capable of imparting optical surfaces to the White Cell's reflecting and/or sealing surfaces (e.g. integral reflecting mirrors 143a and sealing surfaces 143b as suggested by FIG. 2).

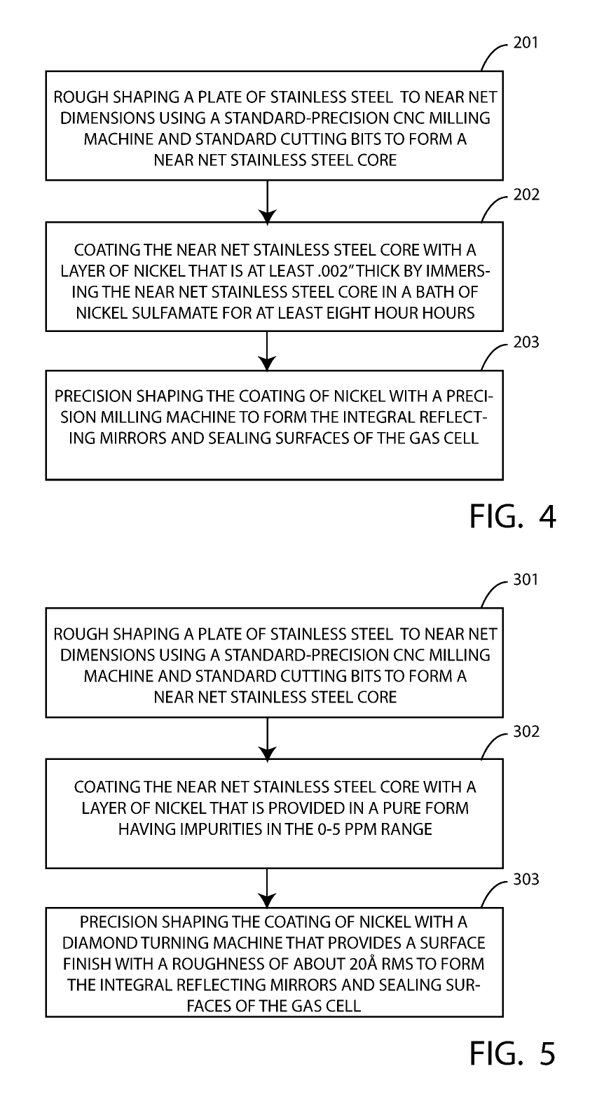

FIGS. 4 and 5 illustrate the steps of second and third preferred embodiments, where the more detailed steps 201, 202, and 203 of FIG. 4 and 301, 302, and 303 of FIG. 5 correspond to like numbered steps in FIG. 3.

It is understood that the exemplary method described herein and shown in the drawings represents only a presently preferred embodiment of the invention. Indeed, various modifications and additions may be made to such embodiment without departing from the spirit and scope of the invention.

I claim:

1. A method of making a corrosion resistant gas cell including an end cap having integral reflecting mirrors and sealing surfaces comprising the steps of:
rough shaping a plate of stainless steel to near net dimensions using standard machining techniques to form a near net stainless steel core;
coating the near net stainless steel core with a layer of nickel to form a nickel coating; and
precision shaping the nickel coating with a precision machine to form the integral reflecting mirrors and sealing surfaces of the gas cell.

2. The method of claim 1 wherein the rough shaping of the stainless steel is accomplished with a standard-precision CNC milling machine and standard cutting bits.

3. The method of claim wherein the coating step produces a layer of nickel coating that is at least 0.002″ thick.

4. The method of claim 3 wherein the coating step comprises the sub-step of immersing the near net stainless steel core in a bath of nickel sulfamate.

5. The method of claim 4 wherein the near net stainless steel core is immersed in the a bath of nickel sulfamate for at least eight hours.

6. The method of claim 1 wherein the nickel used in the coating step is provided in a pure form having impurities in the 0-5 PPM range.

7. The method of claim 6 wherein the nickel used in the coating step is provided in a pure form having impurities in the 0-2 PPM range.

8. The method of claim 1 wherein the precision shaping is accomplished with a precision machine that is capable of achieving sub-nanometer level surface finishes.

9. The method of claim 8 wherein the precision machine provides a surface finish with a roughness of about 20 Å RMS.

10. The method of claim 9 wherein the precision machine is a diamond turning machine.

11. A method of making a corrosion resistant gas cell including an end cap having integral reflecting mirrors and sealing surfaces comprising the steps of:
rough shaping a plate of stainless steel to near net dimensions using a standard-precision CNC milling machine and standard cutting bits to form a near net stainless steel core;
coating the near net stainless steel core with a layer of nickel that is at least 0.002″ thick by immersing the near net stainless steel core in a bath of nickel sulfamate for at least eight hours; and
precision shaping the coating of nickel with a precision milling machine to form the integral reflecting mirrors and sealing surfaces of the gas cell.

12. The method of claim 11 wherein the nickel used in the coating step is provided in a pure form having impurities in the 0-5 PPM range.

13. The method of claim 12 wherein the nickel used in the coating step is provided in a pure form having impurities in the 0-2 PPM range.

14. The method of claim 11 wherein the precision shaping is accomplished with a precision milling machine that is capable of achieving sub-nanometer level surface finishes.

15. The method of claim 14 wherein the precision milling machine provides a surface finish with a roughness of about 20 Å RMS.

16. The method of claim 15 wherein the precision milling machine is a diamond turning machine.

17. A method of making a corrosion resistant gas cell including an end cap having integral reflecting mirrors and sealing surfaces comprising the steps of:
rough shaping a plate of stainless steel to near net dimensions using a standard-precision CNC milling machine and standard cutting bits to form a near net stainless steel core;
coating the near net stainless steel core with a layer of nickel that is provided in a pure form having impurities in the 0-5 PPM range; and
precision shaping the coating of nickel with a diamond turning machine that provides a surface finish with a roughness of about 20 Å RMS to form the integral reflecting mirrors and sealing surfaces of the gas cell.

18. The method of claim 17 wherein the nickel coating is at least 0.002″ thick.

19. The method of claim 17 wherein the nickel coating is formed by immersing the near net stainless steel core in a bath of nickel sulfamate for at least eight hours.
